(19) United States
(12) Patent Application Publication
(10) Pub. No.: US 2026/0048673 A1
(43) Pub. Date: Feb. 19, 2026

(54) EV CHARGING HANDLE WITH STATUS INDICATING LEDS

(71) Applicant: EATON INTELLIGENT POWER LIMITED, DUBLIN 4 (IE)

(72) Inventors: Miguel Medina Pena, Oakdale, PA (US); Nareshkumar Patel, Peachtree City, GA (US); Bryan A. Hain, Darlington, PA (US)

(73) Assignee: EATON INTELLIGENT POWER LIMITED, DUBLIN 4 (IE)

(21) Appl. No.: 19/253,061

(22) Filed: Jun. 27, 2025

Related U.S. Application Data
(60) Provisional application No. 63/666,442, filed on Jul. 1, 2024.

(51) Int. Cl. B60L 53/16; H02J 7/00

(52) U.S. Cl. CPC B60L 53/16; H02J 7/0036; H02J 7/0047

(57) ABSTRACT

An improved EV charger handle with a SAE J3400 connector plug provides the operating status of the charging station and an improved ergonomic design as compared to existing charger handles. In addition, the EV charging handle includes a UHF circuit activation button that enables a user to transmit a UHF signal to an electric vehicle in order to open the charging port on said vehicle. The EV charging handle further includes temperature sensors on the power contact pins of the connector plug.

### CROSS REFERENCE TO RELATED APPLICATIONS

This application claims priority to U.S. Provisional Patent Application Ser. No. 63/666,442, filed on Jul. 1, 2024 and titled “EV CHARGING HANDLE WITH STATUS INDICATING LEDS”, the disclosure of which is incorporated herein by reference.

### FIELD OF THE INVENTION

The disclosed concept relates generally to electric vehicle (EV) charging equipment, and more particularly, to charging handles used to charge EVs.

### BACKGROUND OF THE INVENTION

With the development of electric vehicle (EV) technology, the number of EVs continues to grow rapidly. An EV charger comprises an EV charging station connected to a power supply, with a charging handle that is electrically connected to the power supply and has an interface structured to engage a charging port on an EV. In order to charge an EV battery, a user must physically put a charging handle into engagement with a charging port on the EV. Several factors contribute to the quality of the user experience when using an EV charging handle, including ergonomics and the ability to readily discern the operating status of the EV charging station.

The present invention thus provides a solution that aims to improve discernibility of the operating status and the ergonomics of certain EV chargers.

### SUMMARY OF THE INVENTION

These needs, and others, are met by embodiments of an improved EV charger handle with a SAE J3400 connector plug. The disclosed EV charging handle provides the operating status of the charging station and an improved ergonomic design as compared to existing charger handles. In addition, the EV charging handle includes a UHF circuit activation button that enables a user to transmit a UHF signal to an electric vehicle in order to open the charging port on said vehicle. The EV charging handle further includes temperature sensors on the power contact pins of the connector plug.

In accordance with one aspect of the disclosed concept, an EV charging handle comprises: a cable receiver, a connector plug of J3400 type, a PCBA in electrical communication with the connector plug, a housing that houses the PCBA. The cable receiver is structured to receive a charging cable connected to an EV charging station. The connector plug is structured to interface with a charging port of an electric vehicle and includes: a control pilot (CP) pin, a proximity pilot (PP) pin, a L1 pin, and a L2 pin. The PCBA includes: a CP signal detection circuit in electrical communication with the CP pin, a PP signal detection circuit in electrical communication with the PP pin, and a plurality of status LEDs. The plurality of status LEDs includes a charging indication LED, a fault indication LED, and a normal indication LED. The housing is coupled at a first end to the cable receiver coupled at a second end opposite the first end to the connector plug. The housing is structured to enable the plurality of status LEDs to be visible from the exterior of the housing. The CP signal detection circuit is configured to determine an operating status of a charging station to which the EV charging handle is connected, the operating status being one of a Charging status, Fault status, or Normal status. The CP signal detection circuit is configured to illuminate: the charging indication LED when the operating status is the Charging status, the fault indication LED when the operating status is the Fault status, and the normal indication LED when the operating status is the Normal status.

### BRIEF DESCRIPTION OF THE DRAWINGS

A full understanding of the invention can be gained from the following description when read in conjunction with the accompanying drawings in which:

FIG. 1A is a perspective view of an improved EV charging handle, in accordance with an example embodiment of the disclosed concept;

FIG. 1B is an upright side view of the improved EV charging handle of FIG. 1A;

FIG. 2 is a top view of the improved EV charging handle of FIGS. 1A-1B, showing a protective cover coupled to the top of the housing of the EV charging handle, in accordance with an example embodiment of the disclosed concept; and

FIG. 3 shows a printed circuit board assembly (PCBA) that is housed within the housing of the EV charging handle of FIGS. 1A-2, in accordance with an example embodiment of the disclosed concept.

### DETAILED DESCRIPTION OF THE INVENTION

As employed herein, when ordinal terms such as “first” and “second” are used to modify a noun, such use is simply intended to distinguish one item from another, and is not intended to require a sequential order unless specifically stated.

As employed herein, the term “number” shall mean one or an integer greater than one (i.e., a plurality).

As employed herein, the statement that two or more parts are “connected” or “coupled” together shall mean that the parts are joined together either directly or joined through one or more intermediate parts.

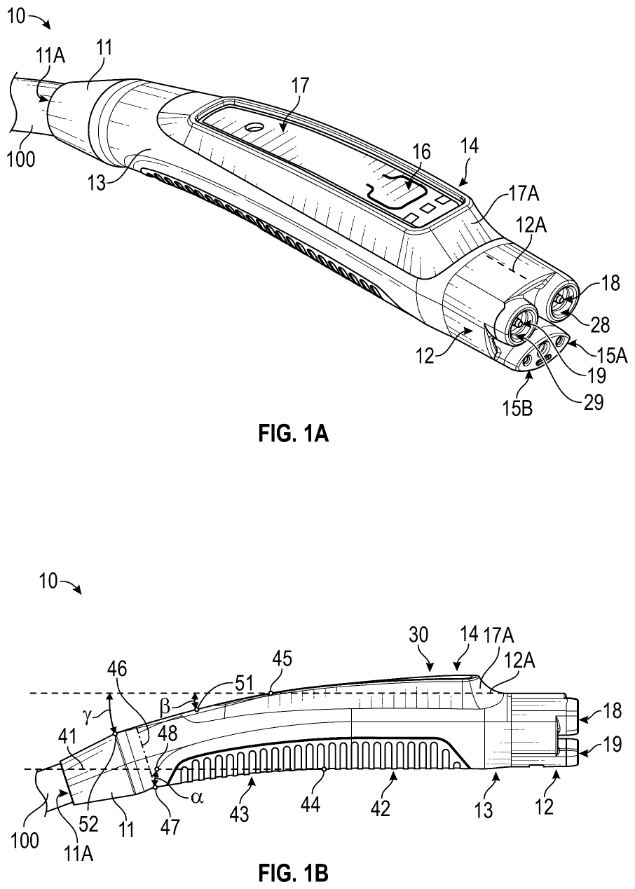

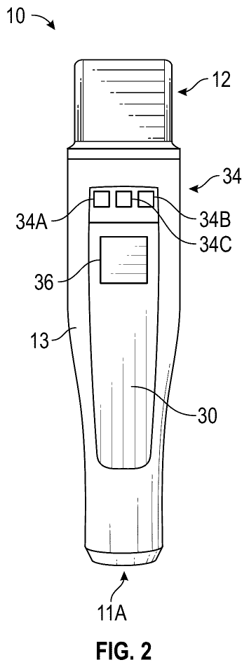

FIGS. 1A-2 show an improved EV charging handle 10, in accordance with an exemplary embodiment of the disclosed concept. As will be made apparent herein, the EV charging handle 10 provides the charging station's operating status and also has an improved ergonomic design as compared to other known EV charging handles. The EV charging handle 10 includes a cable receiver 11 with a cable input opening 11A structured to receive a charging cable 100 in order to connect to a power supply. The EV charging handle 10 is specifically a SAE J3400 type charging handle and thus has a connector plug 12 structured to mechanically and electrically engage with a SAE J3400-compatible charging port of vehicle. As a SAE J3400 (referred to hereinafter the “J3400 for brevity) type charging handle, the EV charging handle 10 is configured to be used with an AC or DC power supply. The charging handle 10 is also configured to have different current ratings.

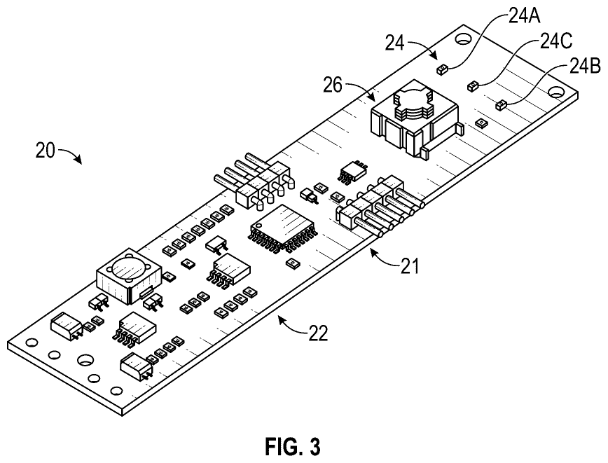

The EV charging handle 10 has a housing 13 that houses various electrical components. Referring to FIG. 3 in conjunction with FIG. 1A, the EV charging handle 10 includes a printed circuit board assembly (PCBA) 20 that is housed in the interior of the housing 13. As shown in FIG. 1A, the housing 13 includes a plurality of LED windows 14. The LED windows 14 align with a corresponding plurality of status LEDs 24 coupled to the PCBA 20, thus enabling the status LEDs 24 to be visible from the exterior of the housing 13.

In accordance with the J3400 standard, the connector plug 12 includes a control pilot (CP) pin 15A and a proximity pilot (PP) pin 15B. The PCBA 20 includes a corresponding control pilot (CP) signal detection circuit 21 (indicated generally in FIG. 3) in electrical communication with the CP pin 15A and a proximity pilot (PP) signal detection circuit 22 (indicated generally in FIG. 3) in electrical communication with the PP pin 15B. The CP signal detection circuit 21 facilitates communication between the electric vehicle and the charging station in order to enable and manage the charging process, including negotiating the charging level and ensuring safety. The PP signal detection circuit 22 detects, via the proximity pin 15B, whether the EV charging handle 10 is properly electrically connected to the charging port of a vehicle in order to charge the battery of the vehicle.

The status LEDs 24 are configured to be selectively illuminated by the CP signal detection circuit 21 in order to indicate the operating status of the charging station at all times when the EV charging handle 10 is connected to a power supply. The operating status can be either Charging, Fault, or Normal, and the plurality of status LEDs 24 includes a corresponding charging indication LED 24A, fault indication LED 24B, and normal indication LED 24C. Each of the charging indication, fault indication, and normal indication LEDs 24A, 24B, 24C can be referred to generally and collectively or generally and individually with the reference number 24. Each of the LED windows 14 that align with the respective charging indication, fault indication, and normal indication LEDs 24A, 24B, 24C can be individually referred to using the respective reference numbers 14A, 14B, 14C (as shown in FIG. 2).

The charging indication LED 24A corresponds to the status of Charging. The charging indication LED 24A will illuminate when the EV charging handle 10 is properly electrically connected to the charging port of a vehicle and supplying current to the EV battery (i.e. the Charging status is only available when the EV charging handle 10 is physically coupled to the charging port of a vehicle). The fault indication LED 24B corresponds to the status of Fault. The fault indication LED 24B will illuminate when there is some fault or error in the EV or EV supply equipment that prevents charging current from being supplied to the EV battery. The normal indication LED 24C corresponds to the status of Normal. The normal indication LED 24C will illuminate when the charging station is operating normally and the EV charging handle 10 is not physically coupled to a vehicle's charging port, such that the EV charging handle 10 and charging station are capable of supplying current to an EV battery in the event that the connector plug 12 is inserted into the charging port of the vehicle.

Among existing J3400 charging handles, there is no visual indication on the charging handle itself to indicate operating status of the charging station (i.e. Charging, Fault, or Normal status), such that the user has to look elsewhere for the operating status, such as the charging station (which connects the charging cable 100 to the power supply) or a mobile device app. The design of the improved EV charging handle 10 disclosed herein thus represents an improvement over existing J3400 charging handles, as the EV charging handle 10 itself provides a visual indication to users of the charging station's operating status.

As shown in FIG. 3, the PCBA 20 includes a UHF button 26 that, when manually actuated (i.e. via pushing), causes the PCBA 20 to generate a UHF (ultra high frequency) signal. As shown in FIG. 1A, the housing 13 includes a UHF tongue formation 16 that can be pushed in order to actuate the UHF button 26 on the PCBA 20. The tongue formation 16 is a cut made in the housing 13 that enables the tongue formation 16 to move relative to the rest of the surrounding surface area of the housing 13, when an external force is exerted on the tongue formation 16. For vehicles compatible with J3400 charging handles and capable of interpreting UHF signals, the generated UHF signal opens the charging port on said vehicles.

As numbered in FIG. 1A, the housing 13 comprises a basin 17. The basin 17 comprises a basin wall 17A that surrounds a depression, and it is noted that the LED windows 14 and the tongue formation 16 are formed in the depression of the basin 17. As numbered in FIG. 2, the EV charging handle 10 further comprises a protective insert 30 that is structured to be inserted into the basin 17. The protective insert 30 and basin 17 can be structured to enable the protective insert 30 to be snap fit into the basin 17. The protective insert 30 provides additional protection to the PCBA 20, by covering the cut in the housing 13 that forms the tongue formation 16. The protective insert 30 includes translucent areas 34A, 34B, 34C that respectively align with and correspond to the LED windows 14A, 14B, 14C so that the LEDs 24 are visible when illuminated. The translucent areas 34A, 34B, 34C can also be referred to generally and collectively or generally and individually using the reference number 34. The protective insert 30 further includes a button marking 36 that aligns with the tongue formation 16 in order to indicate where a user should push in order to actuate the UHF button 26.

It will be appreciated that the LEDs 24, LED windows 14, and translucent areas 34 can be used in a variety of ways to indicate each unique operating status. For example and without limitation, each operating status can be assigned a unique color, such that each LED 24 is uniquely colored relative to the other LEDs 24. In addition to and/or instead of using unique LED colors, each charging status can be assigned a unique icon such that, for each charging status, the corresponding LED window 14 and/or translucent area 34 can be uniquely shaped relative to the LED windows 14 and/or translucent areas 34 of the other charging statuses.

Referring to FIG. 1A, in accordance with the J3400 standard, the connector plug 12 further includes a L1 pin 18 and a L2 pin 19, which are the power contacts used to provide a current path between the power supply and the EV battery. The EV charging handle 10 includes a first thermal sensor 28 positioned to detect the temperature of the L1 pin 18 and a second thermal sensor 29 positioned to detect the temperature of the L2 pin 19. In a non-limiting exemplary embodiment, the thermal sensors 28, 29 are NTC (negative temperature coefficient) sensors.

Reference is now made to FIG. 1B in conjunction with FIG. 1A to discuss the structural aspects of the EV charging handle 10 that render the EV charging handle 10 ergonomically advantageous over existing J3400 charging handles. The orientation of the EV charging handle 10 in which the basin 17 is disposed at the top of the EV charging handle 10 (such that the LED windows 14 are disposed on a top side of the housing 13), as shown in FIG. 1B, will be referred to hereinafter as the “upright orientation” of the EV charging handle 10. In addition, the view of the upright orientation shown in FIG. 1B will be referred to hereinafter as the “upright side view” of the EV charging handle 10. It is noted that the viewing plane of the upright side view is orthogonal to the front side of the connector plug 12 (the front side of the connector plug 12 being the side of the connector plug 12 where the various pins such as the L1 and L2 pins 18, 19 are exposed).

When the EV charging handle 10 is viewed in the upright side view, there is a top center line 12A (also marked in FIG. 1A) of the connector plug 12 that coincides with the top-most point of the connector plug 12 and extends generally towards the cable receiver 11. In the upright orientation, at the side of the basin 17 positioned closest to the connector plug 12, the basin wall 17A extends upward from the top center line 12A and upward from the top of the connector plug 12 generally. In the upright orientation, there is a bottom center line 41 that coincides with a flat portion 42 of the bottom surface of the housing 13 disposed directly opposite the basin 17. The top center line 12A and the bottom center line 41 are parallel.

Continuing to refer to the upright side view shown in FIG. 1B, the bottom surface of the housing 13 also comprises a curved portion 43 that is continuous with the flat portion 42 and positioned between the flat portion 42 and the cable receiver 11. On the bottom side of the housing 13 in the upright side view, when moving toward the cable receiver 11, there is a bottom side divergence point 44 at which the curved portion 43 starts to extend below the bottom center line 41. On the top side of the housing 13 in the upright side view, when moving toward the cable receiver 11, there is a top side divergence point 45 at which the top surface of the housing 13 starts to extend below the top center line 12A. The bottom side divergence point 44 is positioned closer to the connector plug 12 than the top side divergence point 45 is.

Moving from the top side divergence point 45 toward the cable receiver 11 and moving from the bottom side divergence point 44 toward the cable receiver 11, the top surface of the housing 13 extends below and away from the top center line 12A at a faster rate than the bottom surface of the housing 13 extends below and away from the bottom center line 41. For the portion of the housing 13 disposed between the connector plug 12 and the cable receiver 11, this results in the housing 13 being thinnest adjacent to the cable receiver 11, as represented by a width line segment 46 shown in FIG. 1B that extends between the top surface and the bottom surface of the housing 13. In the upright side view, the top surface of the housing 13 is curved between the top side divergence point 45 and the cable receiver 11, and has a greater degree of curvature as compared to the portion of the bottom surface of the housing 13 located between the bottom side divergence point 44 and the cable receiver 11.

There is a bottom point 47 at which the width line segment 46 meets the bottom surface of the housing 13. The bottom point 47 and the bottom side divergence point 44 can be connected by a first ray (said first ray not being separately drawn or numbered in the figures). There is a ray endpoint 48 on the bottom center line 41 disposed directly above the bottom point 47 in the upright side view. The ray endpoint 48 and the bottom side divergence point 44 can be connected by a second ray (said second ray not being separately numbered in the figures). There is an angle alpha (α) positioned between the first ray and the second ray, with the bottom side divergence point 44 being the vertex of alpha. In an exemplary embodiment, alpha is between 5.45° and 5.60°. For example, in one particular embodiment, alpha is about 5.51°. It is noted that, in the upright side view, the bottom surface of the housing 13 is slightly curved between the bottom side divergence point 44 and the cable receiver 11.

For ease of explanation, the plug connector 12 will be treated hereinafter as the front end of the EV charger handle 10, and the cable input opening 11A will be treated hereinafter as the rear end of the EV charger handle 10. As such, when comparing two components, if a first component is positioned closer to the plug connector 12 than the second component is, then the first component is said to be “in front of” the second component. Conversely, when comparing the two components, if the first component is positioned closer to the cable input opening 11A than the second component is, then the first component is said to be “rearward to” the second component.

In the upright side view, there is a front top point 51 at a first location on the top surface of the housing 13, with the front top point 51 being positioned directly underneath the top center line 12A. The front top point 51 is in front of the width line segment 46, and is thus necessarily in front of the bottom point 47 and the ray endpoint 48. There is rear top point 52 at a second location on the top surface of the housing 13, with the rear top point 52 also being positioned directly underneath the top center line 12A. The rear top point 52 is rearward to the width line segment 46, and is thus necessarily rearward to the bottom point 47 and the ray endpoint 48. It is noted that the rear top point 52 is located at the front of the cable receiver 11.

Considering a first ray that connects the top side divergence point 45 to the front top point 51 (said first ray not being separately drawn or numbered in the figures) and a second ray (said first ray not being separately numbered in the figures) that is colinear with the top center line 12A and extends from the top side divergence point 45 toward the rear of the EV charging handle 10, there is an angle β (beta) that is formed by the first ray and the second ray. In an exemplary embodiment, beta is between 11.40° and 11.50°. For example, in one particular embodiment, beta is about 11.47°.

Considering a first ray that connects the top side divergence point 45 to the rear top point 52 (said first ray not being separately drawn or numbered in the figures) and a second ray (said first ray not being separately numbered in the figures) that is colinear with the top center line 12A and extends from the top side divergence point 45 toward the rear of the EV charging handle 10, there is an angle γ (gamma) that is formed by the first ray and the second ray. In an exemplary embodiment, gamma is between 14.55° and 14.65°. For example, in one particular embodiment, beta is about 14.60°.

The angles of alpha, beta, and gamma were carefully chosen in order to increase the ergonomic aspect of the EV charging handle 10. In particular, the angle at which a user must bend their wrist in order to hold the EV charging handle 10 is significantly less than the angle at which a user must bend their wrist to hold existing J3400 chargers.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. An EV charging handle, the EV charging handle comprising:
a cable receiver structured to receive a charging cable connected to an EV charging station;
a connector plug of J3400 type structured to interface with a charging port of an electric vehicle, the connector plug including:
a control pilot, CP, pin;
a proximity pilot, PP, pin;
a L1 pin; and
a L2 pin,
a PCBA in electrical communication with the connector plug, the PCBA including:
a CP signal detection circuit in electrical communication with the CP pin;
a PP signal detection circuit in electrical communication with the PP pin; and
a plurality of status LEDs, the plurality of status LEDs including a charging indication LED, a fault indication LED, and a normal indication LED; and
a housing that houses the PCBA, the housing being coupled at a first end to the cable receiver and being coupled at a second end opposite the first end to the connector plug,
wherein the housing is structured to enable the plurality of status LEDs to be visible from the exterior of the housing,
wherein the CP signal detection circuit is configured to determine an operating status of a charging station to which the EV charging handle is connected, the operating status being one of a Charging status, Fault status, or Normal status, and
wherein the CP signal detection circuit is configured to illuminate: the charging indication LED when the operating status is the Charging status, the fault indication LED when the operating status is the Fault status, and the normal indication LED when the operating status is the Normal status.

2. The EV charging handle of claim 1, further comprising:
a UHF button structured to be manually actuated,
wherein the PCBA is configured to generate a UHF signal when the UHF button is manually actuated.

3. The EV charging handle of claim 1,
wherein the UHF signal is an instruction to open the charging port of the electric vehicle.

4. The EV charging handle of claim 1, further comprising:
a first thermal sensor positioned to detect a temperature of the L1 pin; and
a second thermal sensor positioned to detect a temperature of the L2 pin.

5. The EV charging handle of claim 4,
wherein the first thermal sensor and the second thermal sensor are both NTC sensors.

6. The EV charging handle of claim 1,
wherein the PP signal detection circuit is configured to detect, via the PP pin, whether the EV charging handle is properly electrically connected to the connector port of the electric vehicle in order to charge a battery of the electric vehicle.

7. The EV charging handle of claim 1,
wherein the operating status is the Charging status when the EV charging handle is properly electrically connected to the connector port of the electric vehicle and supplying current to a battery of the electric vehicle.

8. The EV charging handle of claim 1,
wherein the operating status is the Fault status when there is a fault or error in either the electric vehicle, the charging station, or the EV charging handle that prevents the EV charging handle from supplying charging current to the battery of the electric vehicle.

9. The EV charging handle of claim 1,
wherein the operating status is the Normal status when the charging station is operating normally and the EV charging handle is not physically coupled to the charging port of the electric vehicle, such that the EV charging handle and charging station are capable of supplying current to a battery of the electric vehicle in the event that the connector plug is inserted into the charging port.

10. The EV charging handle of claim 1, further comprising:
a basin comprising a basin wall that surrounds a depression,
wherein the LED windows are formed in the depression, and
wherein the EV charging handle is structured such that, when the EV charging handle is positioned in an upright position and viewed from an upright side view, the upright position being a position in which the LED windows are disposed on a top side of the housing:
there is a top center line that coincides with a top-most point of the connector plug and extends towards the cable receiver,
there is a bottom center line that coincides with a flat portion of a bottom surface of the housing disposed directly opposite the basin, with the top center line and the bottom center line being parallel,
the bottom surface of the housing also comprises a curved portion that is continuous with the flat portion and positioned between the flat portion and the cable receiver,
on the bottom side of the housing, when moving toward the cable receiver, there is a bottom side divergence point at which the curved portion starts to extend below the bottom center line,
on the top side of the housing, when moving toward the cable receiver,
there is a top side divergence point at which a top surface of the housing starts to extend below the top center line, and
the bottom side divergence point is positioned closer to the connector plug than the top side divergence point is.

11. The EV charging handle of claim 10,
wherein the EV charging handle is structured such that, when the EV charging handle is positioned in the upright position and viewed from the upright side view:
when moving from the top side divergence point toward the cable receiver and moving from the bottom side divergence point toward the cable receiver, the top surface of the housing extends below and away from the top center line at a faster rate than the bottom surface of the housing extends below and away from the bottom center line.

12. The EV charging handle of claim 11,
wherein the EV charging handle is structured such that, when the EV charging handle is positioned in the upright position and viewed from the upright side view:
the housing is thinnest adjacent to the cable receiver, as represented by a width line segment that extends between the top surface and the bottom surface of the housing.

13. The EV charging handle of claim 12,
wherein the EV charging handle is structured such that, when the EV charging handle is positioned in the upright position and viewed from the upright side view:
there is a bottom point at which the width line segment meets the bottom surface of the housing,
the bottom point and the bottom side divergence point can be connected by a first ray,
there is a ray endpoint on the bottom center line disposed directly above the bottom point,
the ray endpoint and the bottom side divergence point can be connected by a second ray,
there is an angle alpha positioned between the first ray and the second ray, with the bottom side divergence point being the vertex of alpha, and
alpha is between 5.45° and 5.60°.

14. The EV charging handle of claim 13,
wherein alpha is 5.51°.

15. The EV charging handle of claim 13,
wherein the EV charging handle is structured such that, when the EV charging handle is positioned in the upright position and viewed from the upright side view, and when considering the plug connector as being a front end of the EV charging handle and considering the cable input opening as being the rear end of the EV charging handle:
there is a front top point at a first location on the top surface of the housing, with the front top point being positioned directly underneath the top center line,
the front top point is in front of the width line segment, the bottom point, and the ray endpoint,
there is rear top point at a second location on the top surface of the housing, with the rear top point being positioned directly underneath the top center line,
the rear top point is rearward to the width line segment, the bottom point, and the ray endpoint,
considering a third ray that connects the top side divergence point to the front top point and a fourth ray that is colinear with the top center line and extends from the top side divergence point toward the rear of the EV charging handle, there is an angle beta that is formed by the third ray and the second ray, and
wherein beta is between 11.40° and 11.50°.

16. The EV charging handle of claim 15,
wherein beta is 11.47°.

17. The EV charging handle of claim 15,
wherein the EV charging handle is structured such that, when the EV charging handle is positioned in the upright position and viewed from the upright side view:
there is a fifth ray that connects the top side divergence point to the rear top point and a sixth ray that is colinear with the top center line and extends from the top side divergence point toward the rear of the EV charging handle,
there is an angle gamma that is formed by the first ray and the second ray, and
gamma is between 14.55° and 14.65°.

18. The EV charging handle of claim 17,
wherein gamma is 14.60°.

19. The EV charging handle of claim 15,
wherein the rear top point is located at the front of the cable receiver.

20. The EV charging handle of claim 10,
wherein the connector plug has a front side where the L1 pin and L2 pin are exposed, and
wherein a viewing plane of the upright side view is orthogonal to the front side of the connector plug.
